(19) United States
(12) Patent Application Publication
(10) Pub. No.: US 2005/0158582 A1
(43) Pub. Date: Jul. 21, 2005

(54) Organic electroluminescent element

(75) Inventors: Toshihiro Ise, Kanagawa (JP); Tatsuya Igarashi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/028,038

(22) Filed: Jan. 4, 2005

(30) Foreign Application Priority Data
Jan. 15, 2004 (JP) 2004-007611

(51) Int. Cl. H05B 33/14

(52) U.S. Cl. 428/690; 428/917; 313/504; 313/506

(57) ABSTRACT

The present invention relates to an organic electroluminescent element having a pair of electrodes, and at least one organic compound layer including a luminescent layer between the pair of electrodes. The luminescent layer contains a fluorescent, which emits fluorescent light when voltage is applied to the element, a sensitizer for amplifying the number of singlet excitons that occur when voltage is applied to the element so as to amplify the luminous intensity of the fluorescent, and other materials.

### CROSS-REFERENCE TO RELATED APPLICATION

This application claims priority under 35 USC 119 from Japanese Patent Application No. 2004-007611, the disclosure of which is incorporated by reference herein.

### BACKGROUND OF THE INVENTION

1. Field of the Invention

The present invention relates to a luminescent element capable of luminescence by converting electric energy to light. Specifically, the invention relates to an organic electroluminescent element (hereinafter referred to as an organic EL element or simply as a luminescent element).

2. Description of the Related Art

Organic electroluminescence (EL) elements have attracted attention as a promising display element, since they can provide luminescence having high brilliance at a low voltage. One of the important characteristic values of the organic electroluminescent elements is external quantum efficiency. External quantum efficiency is calculated from the following formula:
External quantum efficiency φ=(number of photons emitted from element)/(number of electrons injected to element)

As the value increases, i.e., as the number of photons emitted increases relative to the number of the electrons injected to the element, the element becomes advantageous in view of power consumption.

Specifically, the external quantum efficiency of the organic electroluminescent element is determined by the following formula.
External quantum efficiency φ=(internal quantum efficiency)×(light extraction efficiency)

The threshold value of the internal quantum efficiency of organic EL elements utilizing fluorescent light emitted from an organic compound is 25%, and the light extraction efficiency thereof is about 20%. Therefore, the threshold value of the external quantum efficiency thereof is thought to be about 5%.

An element including a triplet luminescent material (phosphorescent luminescent material) has been reported as an organic electroluminescent element which has an improved internal quantum efficiency, and in turn an improved external quantum efficiency (for example, see WO 2000/070655). The external quantum efficiency of this element can be much higher than that of a conventional element utilizing emission of fluorescent light (singlet luminescent element), and the maximum value of external quantum efficiency of the element reaches 8% (external quantum efficiency at 100 cd/m² is 7.5%). However, the luminescence response is slow due to use of phosphorescent luminescence from a heavy atom metal complex. In addition, improvement in durability of the element has been desired.

In order to solve such problems, a singlet luminescent element utilizing energy transfer from triplet exciton to singlet exciton has been reported (for example, see WO2001/008230). An example of the structure of such an element has, as shown in FIG. 1, two layers, namely a fluorescent-containing layer and a sensitizer-containing layer, each containing 4,4′-N,N′-dicarbazolebiphenyl (CBP) as a host material. However, the element disclosed in the document, that is, an element having a structure as shown in FIG. 1, has a maximum external quantum efficiency of 3.3%, which does not exceed the external quantum efficiency of a conventional singlet luminescent element (φ=5%). Therefore, further improvement in luminescence efficiency of the element has been demanded.

Accordingly, there is a need for a luminescent element having good luminescence efficiency.

### SUMMARY OF THE INVENTION

The above-mentioned need has been satisfied by the following invention.

The invention provides An organic electroluminescent element including: a pair of electrodes; and at least one organic compound layer including a luminescent layer between the pair of electrodes, wherein the luminescent layer contains a fluorescent, which emits fluorescent light when voltage is applied to the element, a sensitizer for amplifying the number of singlet excitons that occur when voltage is applied to the element so as to amplify the luminous intensity of the fluorescent, and other materials.

The organic electroluminescent element of the invention has high luminescence efficiency and can achieve luminescence having high brilliance.

### BRIEF DESCRIPTION OF THE DRAWINGS

FIG. 1 is a cross-sectional view schematicaly showing the structure of a luminescent layer disclosed in WO2001/008230.

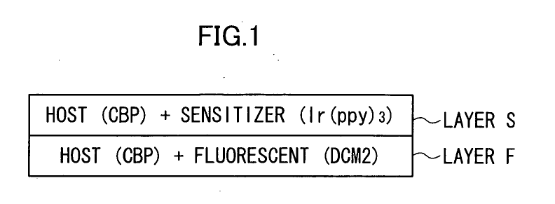

FIGS. 2A and 2B are cross-sectional views each schematically showing one embodiment of the luminescent layer of an organic electroluminescent element of the invention having a layer containing a sensitizer and a host material and a layer containing a fluorescent and at least one host material.

FIG. 3A to 3C are cross-sectional view each schematically showing one embodiment of the luminescent layer of an organic electroluminescent element of the invention having a layer containing a sensitizer and a layer containing a fluorescent, wherein at least one of these layers contains two host materials.

### DETAILED DESCRIPTION OF THE INVENTION

The organic electroluminescent element of the invention has at least one organic compound layer including a luminescent layer between a pair of electrodes, and the luminescent layer contains a fluorescent, namely a compound which emits fluorescent light when voltage is applied to the element. In the invention, luminescence when voltage is applied to the element is mainly derived from the fluorescent.

The phrase “luminescence when voltage is applied to the element is mainly derived from the fluorescent” means that not less than 51% of luminescence components obtained from the element are those from singlet excitons (fluorescence) and that the residual, not more than 49%, are those from triplet excitons (phosphorescence). In the invention, it is preferable that not less than 70% of the luminescence components obtained from the element be fluorescence and that not more than 30% be phosphorescence. It is more preferable that not less than 80% be fluorescence and that not more than 20% be phosphorescence. It is the most preferable that not less than 90% be fluorescence and that not more than 10% be phosphorescence. When the luminescence is mainly fluorescence, response and durability of luminescence can be improved and a decrease in efficiency at high brilliance (for example, at 1000 cd/m² or more) can be suppressed.

The luminescent element of the invention also contains, in the luminescent layer, a sensitizer, namely a compound for amplifying the number of singlet excitons that occur when voltage is applied to the element so as to amplify the luminosity of the fluorescent. The luminescent element of the invention can contain any sensitizer, so long as the sensitizer amplifies the number of singlet excitons that occur when voltage is applied to the element. Examples thereof include a compound having a function for transferring energy from the triplet exciton that occurs in the luminescent element to the singlet exciton in the fluorescent or the host material. Examples of the compound having such a function include a compound that emits phosphorescence at 20° C., and the quantum yield of phosphorescence of such a compound is preferably not less than 50%, more preferably not less than 70%, and still more preferably not less than 90%. The compound can be a transition metal complex.

The transition metal complex is preferably an iridium complex, a platinum complex, a rhenium complex, a ruthenium complex, a palladium complex, a rhodium complex, a copper complex, or a rare earth complex, and is more preferably an iridium complex, or platinum complex.

Specific examples of the transition metal complex that is used as the sensitizer in the invention include those disclosed in U.S. Pat. No. 6,303,231 B1, U.S. Pat. No. 6,097,147, WO 00/57676, WO 00/70655, WO 01/08230, WO 01/39234 A2, WO 01/41512 A1, WO 02/02714 A2, WO 02/15645 A1, Japanese Patent Application Laid-Open (JP-A) No. 2001-247859, Japanese Patent Applications Nos. 2000-33561, 2001-189539, 2001-248165, 2001-33684, 2001-239281 and 2001-219909, EP 1,211,257, JP-A Nos. 2002-226495, 2002-234894, 2001-247859, 2001-298470, 2002-173674, 2002-203678 and 2002-203679, Nature, Vol. 395, p. 151 (1998), Applied Physics Letters, Vol. 75, p. 4 (1999), Polymer Preprints, Vol. 41, p. 770 (2000), Journal of American Chemical Society, Vol. 123, p. 4304 (2001) and Applied Physics Letters, Vol. 79, p. 2082 (1999).

The concentration of the sensitizer in the organic compound layer is not particularly limited, but is preferably 0.1 to 9 mass %, more preferably 1 to 8 mass %, still more preferably 2 to 7 mass %, and most preferably 3 to 6 mass %. This is because efficiency and durability of the element can be improved.

The fluorescence quantum yield of the fluorescent in the invention is preferably not less than 70%, more preferably not less than 80%, still more preferably not less than 90%, and most preferably not less than 95%. The fluorescence quantum yield can be a value measured by a conventional method in a solid film or a solution at 20° C.

Although the fluorescent in the invention is not specifically limited, it is preferably a condensed aromatic ring compound. Examples of the condensed aromatic ring compound include compounds having a condensed aromatic hydrocarbon ring (for example, naphthalene, anthracene, phenanthrene, acenaphthylene, pyrene, perylene, fluoranthene, tetracene, chrysene, pentacene and coronene), and derivatives thereof (for example, tetra-t-butylpyrene, binaphthyl, rubrene, benzopyrene and benzoanthracene), compounds having a condensed aromatic hetero ring (for example, quinoline, quinoxaline, benzimidazole, benzoxazole, benzimidazole, imidazopyridine and azaindole), and derivatives thereof (for example, bisbenzoxazolylbenzene and benzoquinoline). The fluorescent is preferably a compound having a condensed aromatic hydrocarbon ring.

The luminescent element of the invention has at least a hole transport layer, a luminescent layer and an electron transport layer. The luminescent layer includes at least one compound that emits fluorescence when voltage is applied to the element. Of the total luminescence obtained from the element, the proportion of luminescence from the fluorescent in the luminescent layer is preferably not less than 80%, more preferably not less than 85% and still more preferably not less than 90%. The luminescence obtained from the element includes not only the luminescence from the fluorescent in the luminescent layer, but also luminescence from a sensitizer, luminescence from a host material, luminescence from an electron transport layer, and luminescence from a hole transport layer.

The proportion of the luminescence from the sensitizer is preferably decreased from the viewpoint of improvement in response of the luminescence. Decreasing luminescence from the host material, the electron transport layer and the hole transport layer means decreasing unamplified luminescence, and is perferable in light of improvement in efficiency of the element.

The luminescent element of the invention includes a fluorescent, a sensitizer and at least two other materials in the luminescent layer. The at least two materials are preferably host materials other than 4,4′-N,N′-dicarbazole-biphenyl (CBP). The host materials mean materials of the luminescent layer other than the fluorescent and the sensitizer, and include those having at least one function selected from a function for holding the fluorescent and the sensitizer in the lumescent layer in a dispersed state, a function for receiving holes from a positive electrode and/or the hole transport layer, a function for receiving electrons from a negative electrode and/or the electron transport layer, a function for transporting holes or electrons, a function for providing a field where holes and electrons and recombined with each other, a function for transferring energy from excitons generated by the recombination to a luminescent material, and a function for transporting holes or electrons to the luminescent material.

Since the host material generates at least one cation and/or anion radical due to its function, the host material is preferably stable with respect to electrochemical oxidization and/or reduction (preferably both oxidization and reduction). Furthermore, when recombination occurs on the host material, the host material is excited to singlet and triplet states. Therefore, it is preferable that the host material which has been excited to singlet and triplet states hardly decomposes. Moreover, since decomposition of materials and breakage of a thin film due to heat during driving is one of main causes of deterioration of the element, it is preferable that the host material be stable with respect to heat and can be amorphous even at high temperature.

Examples of the host material include, but are not limited to, compounds (1-1) to (1-34) disclosed in JP-A No. 2003-27048; compounds (A-1) to (A-33), (B-1) to (B-62), (C-1) to (C-72), (D-1) to (D-75) and (E-1) to (E-5) disclosed in JP-A No. 2002-100476; Exemplified compounds 1 to 60 disclosed in JP-A No. 2002-193952; compounds 1 to 381 disclosed in JP-A No. 2002-319491; compounds 1 to 37 disclosed in JP-A No. 2000-119644; compounds 1 to 58 disclosed in JP-A No. 2003-217856; compounds (I-1) to (I-12) disclosed in Japanese Patent Application No. 2002-241663; compounds (I-1) to (I-16) and (II-1) to (II-9) disclosed in Japanese Patent Application No. 2002-241662; compounds 1 to 26 disclosed in Japanese Patent Application No. 2002-252803; compounds 1 to 82 disclosed in JP-A No. 2002-38141; compounds 1 to 47 disclosed in JP-A No. 2001-24758; compounds 1 to 99 disclosed in JP-A No. 2001-192653; compounds (HT-1) to (HT-20) disclosed in JP-A No. 2001-284051; compounds (H-1) to (H-24) disclosed in Japanese Patent Application No. 2002-140589; compounds (H-1) to (H-26) disclosed in Japanese Patent Application No. 2002-140590; compounds (E-1) to (E-66) disclosed in JP-A No. 2002-338579; compounds (E-1) to (E-53) disclosed in JP-A No. 2002-356489; compounds (1-1) to (1-44) disclosed in JP-A No. 2001-192651; compounds (1-1) to (1-30), (2-1) to (2-22), (3-1) to (3-13), (4-1) to (4-35) and (5-1) to (5-8) disclosed in JP-A No. 12-351966; compounds (1-1) to (1-26) disclosed in JP-A No. 2001-192652; compounds (H-1) to (H-38) disclosed in JP-A No. 2002-305084; and complex host materials disclosed in Japanese Patent Application No. 2003-285755.

The luminescent layer of the luminescent element of the invention preferably has a layered structure of a layer containing the fluorescent (hereinafter also referred to as a layer F) and a layer containing the sensitizer (hereinafter also referred to as a layer S). When the layered structure has two or more layers containing the fluorescent and two or more layers containing the sensitizer, the layers containing the fluorescent are alternated with the layers containing the sensitizer. In the invention, the sum of the number of the layers containing the fluorescent and the number of the layers containing the sensitizer in the luminescent layer is preferably 12 to 50. In other words, the luminescent layer preferably has 6 to 25 pairs of the layer containing the fluorescent and the layer containing the sensitizer. It is more preferable that the sum of the number of the layers containing the fluorescent and the number of the layers containing the sensitizer in the luminescent layer be 16 to 30.

The host material may be included in at least one of the layer containing the fluorescent and the layer containing the sensitizer, or may be included in both of these layers.

When the luminescent layer has the above-mentioned layered structure and both the layer containing the fluorescent and the layer containing the sensitizer contain the host material(s), the host material(s) contained in the layer containing the fluorescent may be the same as or different from the host material(s) contained in the layer containing the sensitizer. In this case, it is necessary that the luminescent layer includes two or more host materials.

Examples of the structure of the luminescent layer having the layer containing the fluorescent and the layer containing the sensitizer include the following two structures.
(1) A structure where the layer containing the fluorescent contains a host material and the layer containing the sensitizer contains another host material
(2) A structure where at least one of the layer containing the fluorescent and the layer containing the sensitizer contains at least two host materials

In the structure (2), the layer containing the fluorescent and the layer containing the sensitizer may contain the same host material(s). However, it is essential that the luminescent layer contains at least two host materials. The luminescent layer may contain at least three host materials.

Embodiments of the luminescent layer having such a layered structure will be specifically explained with referring to drawings, however the invention is not limited to these specific examples.

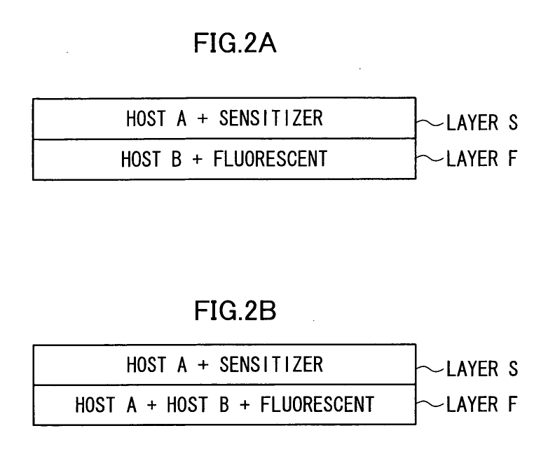

FIG. 2 is a cross-sectional view schematically showing the structure of the luminescent layer of an organic electroluminescent element of the invention which luminescent layer has a layer S containing a sensitizer and a material and a layer F containing a fluorescent and at least one host material. For example, the above-mentioned structure (1) is shown in FIG. 2A. In FIG. 2A, a layer S contains a sensitizer and a host material A and a layer F contains a fluorescent and a host material B different from the host material A. FIG. 2B shows an embodiment wherein a layer S contains a sensitizer and a host material A and a layer F contains a fluorescent and host materials A and B.

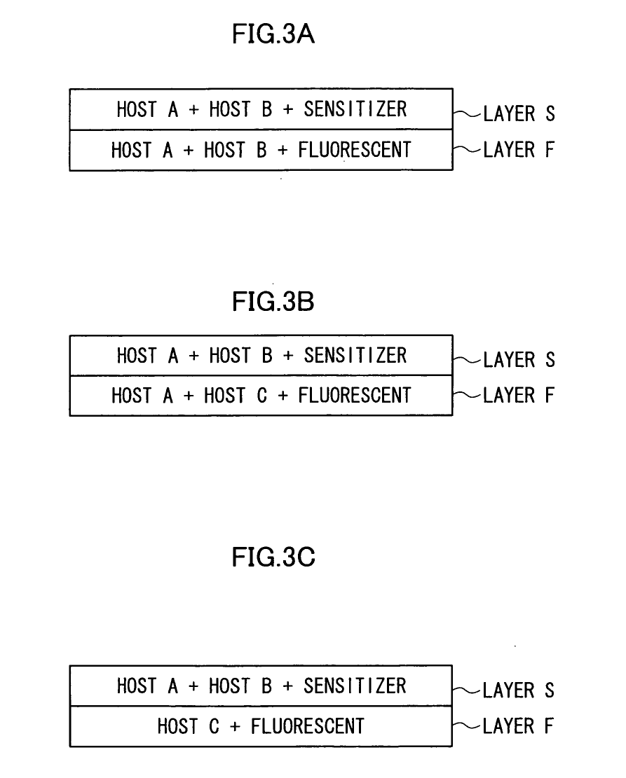

FIG. 3 is a cross sectional view schematically showing the luminescent layer of an organic electroluminescent element of the invention which luminescent layer has a layer S containing a sensitizer and a layer F containing a fluorescent, wherein at least one of these layers contains at least two host materials. For example, FIG. 3A shows an embodiment wherein both a layer S containing a sensitizer and a layer F containing a fluorescent contain host materials A and B. In this embodiment, the host materials included in the layer S are the same as those included in the layer F, and the luminescent layer as a whole contains two host materials. FIG. 3B shows an embodiment wherein a layer S contains a sensitizer and host materials A and B and a layer F contains a fluorescent and host materials A and C. In this embodiment, the layers S and F contain the same host material and also contain different host materials, and the luminescent layer as a whole contains three host materials. FIG. 3C shows an embodiment wherein a layer S contains a sensitizer and host materials A and B and a layer F contains a fluorescent and a host material C. In this embodiment, the host materials contained in the layer S are different from the host material contained in the layer F, and the luminescent layer as a whole contains three host materials.

It is preferable that the luminescent element of the invention emits luminescence at the central portion of the luminescent layer. When luminescence is emitted at the central portion of the luminescent layer, it is possible to decrease the difference obtained by subtructing external quantum efficiency when a layer adjacent to the luminescent layer, such as a hole transport layer, an exciton blocking layer, a hole blocking layer, or an electron transport layer, includes a compound that quenches triplet excitons from that when the layer adjacent to the luminescent layer does not contain such a compound. Specifically, when the luminescent element of the invention emits luminescence at the central portion of the luminescent layer, the above difference can be not more than 20%. In other word, the position of luminescence can be determined from the difference in external quantum efficiency. In obtaining the difference, external quantum efficiency of a luminescent element can be measured.

The glass transition temperature of each of the host materials to be included in the luminescent layer in the invention is preferably 90° C. to 400° C., more preferably 100° C. to 380° C., still more preferably 120° C. to 370° C., and most preferably 140° C. to 360° C.

Next, the luminescent element containing the above-described materials will be explained. The system for the luminescent element and the driving method and usage of the luminescent element are not particularly limited. A typical example of the luminescent element is an organic electroluminescent element.

The method for producing an organic compound layer of the luminescent element of the invention containing the above-described materials is not limited. Examples thereof include a resistance heating deposition method; an electron beam method; sputtering; a molcule-laminating method; a coating method such as a spray coating method, a dip coating method, an impregnating method, a roll coating method, a gravure coating method, a reverse coating method, a roll brushing method, an air knife coating method, a curtain coating method, a spin coating method, a flow coating method, a bar coating method, a micro gravure coating method, an air doctor coating method, a blade coating method, a squeeze coating method, a transfer roll coating method, a kiss coating method, a cast coating method, an extrusion coating method, a wire bar coating method, and a scree coating method; an ink-jet method; a printing method; and a transferring method. The production method is preferably a resistance heating deposition method, a coating method or a transferring method from the viewpoints of characteristics and production.

In the luminescent element of the invention, a luminescent layer or a plurality of organic compound films including the luminescent layer are disposed between a pair of positive and negative electrodes. The luminescent element may have a hole injecting layer, a hole transport layer, an electron injecting layer, an electron transport layer, and a protective layer, as well as the luminescent layer. Each of these layers may have another function. Various materials can be used to form each of these layers.

The positive electrode is provided to supply holes to the hole injecting layer, the hole transport layer, and/or the luminescent layer, and can be made of a metal, an alloy, a metal oxide, or an electrically conductive compound, or a mixture thereof, and is preferably made of a material having a work function of 4 eV or more.

Typical examples of the material of the positive electrode include electrically conductive metal oxides such as tin oxide, zinc oxide, indium oxide, and indium tin oxide (ITO); metals such as gold, silver, chromium, and nickel; mixtures and laminated products of these metals and the electrically conductive metal oxides; electrically conductive inorganic substances such as copper iodide, and copper sulfide; electrically conductive organic substances such as polyaniline, polythiophene, and polypyrrole; and laminated products of the electrically conductive organic substances and ITO. The material of the positive electrode is preferably an electrically conductive metal oxide. The material is more preferably ITO from the viewpoints of productivity, high electrical conductivity and transparency. The thickness of the positive electrode can be suitably determined according to the material of the positive electrode, but is preferably 10 nm to 5 μm, more preferably 50 nm to 1 μm, and still more preferably 100 to 500 nm.

The positive electrode is usually an article having a layer of at least one of the above-described materials on a substrate made of soda lime glass, no-alkali glass, or a transparent resin. When the substrate is made of glass, the glass is preferably no-alkali glass in order to lessen ions deriving from the glass. When the substrate is made of soda lime glass, the substrate is preferably coated with a barrier coating such as silica. The thickness of the substrate is not limited, as long as the substrate has sufficient mechanical strength. However, when the substrate is made of glass, the thikcness thereof is generally 0.2 mm or more, and preferably 0.7 mm or more.

A method for producing a positive electrode is selected according to the material of the positive electrode. When the positive electrode is an ITO film, the ITO film is formed by an electron beam method, a sputtering method, a resistance heating deposition method, a chemical reaction method (e.g., a sol-gel method), or a method of applying a dispersion of indium tin oxide.

The positive electrode can be subjected to washing or other treatment to lower the driving voltage of the element and/or to enhance luminescence efficiency. When the positive electrode is made of ITO, UV-ozone treatment or plasma treatment is effective as such treamtent.

The negative electrode is provided to supply electrons to the electron injecting layer, the electron transport layer, and/or the luminescent layer, and the material of the negative electrode is selected in consideration of adhesion between the negative electrode and a layer adjacent to the negative electron, such as the electron injecting layer, the electron transport layer, and/or the luminescent layer, and ionization potential and stability of the material.

The negative electrode can be made of a metal, an alloy, a metal halide, a metal oxide, or an electrically conductive compound, or a mixture thereof. Specific examples of the material of the negative electrode include alkali metals such as lithium, sodium, and potassium, and fluorides and oxides thereof; alkaline earth metals such as magnesium and calcium, and fluorides and oxides thereof; gold, silver, lead, aluminum, and an sodium-potassium alloy, and mixed metals of these materials; a lithium-aluminum alloy and mixed metals including the lithium-aluminum alloy; a magnesium-silver alloy and mixed metals including the magnesium-silver alloy; and rare earth metals such as indium and ytterbium. The negative electrode is preferably made of a material selected from the above materials and having a work function of 4 eV or less. The material of the negative electrode is more preferably aluminum, a lithium-aluminum alloy or a mixed metal including the lithium-aluminum alloy, or a magnesium-silver alloy or a mixed metal including the magnesium-silver alloy.

The negative electrode can be one layer of any of the above-described materials or multilayers including one or more of the above-described materials. For example, the negative electrode preferably has a layered structure of aluminum/lithium fluoride, or aluminum/lithium oxide. The thickness of the negative electrode can be suitably determined according to the material of the negative electrode. However, the thickness is preferably 10 nm to 5 μm, more preferably 50 nm to 1 μm, and sill more preferably 100 nm to 1 μm.

The negative electrode is formed by an electron beam method, a sputtering method, a resistance heating method, a coating method, or a transferring method. One metal can be vapor-deposited, or at least two metals can be vapor-deposited simultaneously. In order to form an alloy electrode, at least two metals can be vapor-deposited simultaneously, or an alloy prepared in advance can be vapor-deposited.

The sheet resistance of each of the positive and negative electrodes is preferably low, and, specifically, is preferably several hundreads ohm/or less.

Other materials of the luminescent layer are not particularly limited, as long as they can form a layer having a function of injecting holes to the positive electrode, the hole injecting layer or the hole transport layer and receiving electrons from the negative electrode, the electron injecting layer, or the electron transport layer when voltage is applied to the element, a function of transferring the received electrons, or a function of providing a field where holes are recombined with electrons to emit light. Examples of the materials of the luminescent layer other than the fluorescent, the sensitizer and the above-described two materials include benzoxazole, benzimidazole, benzothiazole, styrylbenzene, polyphenyl, diphenylbutadiene, tetraphenylbutadiene, naphthalimide, coumarin, perylene, perynone, oxadiazole, aldazine, pyralidine, cyclopentadiene, bisstyrylanthracene, quinacridone, pyrrolopyridine, thiadiazolopyridine, styrylamine, aromatic dimethylidyne compounds, metal complexes including metal complexes and rare earth metal complexes of 8-quinolinol, polymeric compounds including polythiophene, polyphenylene, polyphenylene vinylene, organic silane, indium trisphenylpyridine complex, and transition metal compexes including platinum porphyrin, and derivatives thereof.

The thickness of the luminescent layer of the luminescent element of the invention is not specifically limited, but is generally in a range of 1 nm to 5 μm, more preferably in a range of 5 nm to 1 μm, and still more preferably in a range of 10 nm to 500 nm.

A method for forming a luminescent layer can be suitably selected depending on the desired structure of the luminescent layer, such as a monolayer structure and a layered structure. Examples of the method include, but are not limited to, a resistance heating deposition, an electron beam method, spattering, a molecul-laminating method, a coating method, an ink-jet method, a printing method, an LB method and a transferring method. The method is preferably a resistance heating deposition or a coating method.

The luminescent layer in the luminescent element may have a monolayered or multilayered structure. In a case of a multilayered luminescent layer, each layer of the luminescent layer may produce light having a different color in order that the multi-layered luminescent layer produces, for example, white color luminescence. Alternatively, white color luminescence may be produced from a single luminescent layer.

The materials of the hole injecting layer and hole transport layer may have one of a function for receiving holes from a positive electrode, a function for transporting holes and a function for blocking electrons injected from a negative electrode. Specific examples thereof include carbazole, triazole, oxazole, oxadiazole, imidazole, polyarylalkane, pyrazoline, pyrazolone, phenylenediamine, arylamine, amino-substituted chalcone, styrylanthracene, fluorenone, hydrazone, stilbene, silazane, an aromatic tertiary amine compound, a styrylamine compound, an aromatic dimethylidyne compound and a porphyrin compound; a polysilane compound, poly(N-vinylcarbazole), an aniline copolymer, electroconductive polymers or oligomers such as thiophene oligomer and polythiophene; organic silanes; carbon films; and derivatives thereof.

The thickness of each of the hole injecting layer and the hole transport layer is not specifically limited, but is preferably in a range of 1 nm to 5 μm, more preferably 5 nm to 1 μm, and still more preferably 10 nm to 500 nm. Each of the hole injecting layer and the hole transport layer may have a monolayered structure including one or more of the above-mentioned materials, or a multilayered structure including multiple layers having the same composition or different compositions.

The hole injecting layer and the hole transport layer are formed by a vacuum deposition method, an LB method, a method in which a hole injecting or transport material is dissolved or dispersed in a solvent and the resultant coating solution is applied to a substrate or any other layer, an ink-jet method, a printing method, or a transferring method.

In a case of a coating method, the above-described material and a resin component may be dissolved or dispersed in a solvent. Examples of the resin component include polyvinyl chloride, polycarbonate, polystylene, polymetyl methacrylate, polybutyl methacrylate, polyester, polysulfone, polyphenylene oxide, polybutadiene, poly(N-vinylcarbazole), hydrocarbon resins, ketone resins, phenoxy resins, polyamide, ethylcellulose, vinyl acetate resins, polyurethane resins, melamine resins, unsaturated polyester resins, alkyd resins, epoxy resins, and silicone resins.

The materials of the electron injecting layer and the electron transport layer may have one of a function of receiving electrons from a negative electrode, a function of transporting electons, and a function of blocking holes injected from a positive electrode. Specific examples thereof include triazole, oxazole, oxadiazole, imidazole, fluorenone, anthraquinodimetane, anthrone, diphenylquinone, thiopyran dioxide, carbodiimide, fluorenylidene methane, distyrylpyrazine, naphthalene, aromatic tetracarboxlic acide anhydride, phthalocyanine, metal complexes including metal complexes of 8-quinolinol, metal phthalocyanine and metal complexes with benzoxazole and/or benzothiazole ligands, organic silanes; and derivatives thereof.

The thickness of each of the electron injecting layer and the electron transport layer is not specifically limited, but is preferably in a range of 1 nm to 5 μm, more preferably 5 nm to 1 μm, and still more preferably 10 nm to 500 nm. Each of the electron injecting layer and the electron transport layer may have a monolayered structure including one or more of the above-mentioned materials, or a multilayered structure with multiple layers having the same composition or different compositions.

The electron injecting layer and the electron transport layer are formed by a vacuum deposition method, an LB method, a method in which an electron injecting or transport material is dissolved or dispersed in a solvent and the resultant coating solution is applied to a substrate or any other layer, an ink-jet method, a printing method, or a transferring method. In a case of a coating method, the above-described material and a resin component may be dissolved or dispersed in a solvent. Examples of the resin component include those exemplified as the resin component which is dissolved or dispersed in a solvent together with the hole injecting or transport material.

The material of the protective layer may have a function of preventing substances that accelerate deterioration of the element, such as moisture and oxygen, from entering the element. Specific examples thereof include metals such as In, Sn, Pb, Au, Cu, Ag, Al, Ti, and Ni; metal oxides such as MgO, SiO, SiO₂, Al₂O₃, GeO, NiO, CaO, BaO, Fe₂O₃, Y₂O₃, and TiO₂; metal fluorides such as MgF₂, LiF, AlF₃, and CaF₂; nitrides such as SiNₓ, and SiOₓN_{y}; polyethylene, polypropylene, polymethyl methacrylate, polyimide, polyurea, polytetrafluoroethylene, polychloro-trifluoroethylene, polydichloro-difluoroethylene, a chloro-trifluoroethylene/dichloro-difluoroethylene copolymer, copolymer obtained by copolymerizing a monomer mixture including tetrafluoroethylene and at least one comonomer, fluorinated copolymers having a ring structure in the main chain of the copolymer, water-absorbing substances having a coefficient of water absorption of at least 1%, and moisture-preventive substances having a coefficient of water absorption of at most 0.1%.

A method for forming a protective layer is not particularly limited. Examples thereof include a vacuum deposition method, a sputtering method, a reactive sputtering method, a molecular beam epitaxy (MBE) method, a cluster ion beam method, an ion-plating method, a plasma polymerization method (radiofrequency ecitation ion-plating method), a plasma CVD method, a laser CVD method, a thermal CVD method, a gas source CVD method, a coating method, a printing method, and a transferring method.

Light-extraction efficiency of the luminescent element of the invention can be improved by various known techniques. For example, light-extraction efficiency and in turn external quantum efficiency can be improved by modifying a substrate surface profile (for example, formation of finely irregular pattern), controlling the refractive indices of a substrate, an ITO layer and an organic layer, or controlling the thicknesses of the substrate, the ITO layer and the organic layer.

The luminescent element of the invention may have a so-called top-emission structure, in which luminescence is output from a positive electrode.

Examples of the material of the substrate of the luminescent element of the invention include, but are not limited to, inorganic materials such as yttrium stabilized with zirconium, and glass; polymeric materials including polyesters such as polyethylene terephthalate, polybutylene terephthalate and polyethylene naphthalate, polyethylene, polycarbonate, polyethersulfone, polyarylate, allyldiglycolcarbonate, polyimide, polycycloolefin, norbornene resins, poly(chloro-trifluoroethylene), Teflon® (polytetrafluoroethylene) and polytetrafluoroethylene-polyethylene copolymers.

The luminescent element of the invention can be suitably used in fields of a display element, a display, a backlight, electrophotography, a light source for illumination, a light source for recording, a light source for exposure, a light source for reading, a sign, a sign board, interior, and optical communication.

### EXAMPLES

Hereinafter, the invention is explained with referring the following examples, but the invention is not limited to these examples.

### Comparative Example 1

An indium tin oxide (ITO) substrate was washed and put into a vapor deposition device, and N,N′-diphenyl-N,N′-di(m-tolyl)benzidine (TPD) was vapor-deposited thereon to form a first layer having a thickness of 50 nm. A compound A having a structure shown below and rubrene having a structure shown below were vapor-deposited on the first layer at a ratio of 99:1 to form a secondary layer having a thickness of 1 nm. Next, the compound A and Ir(ppy)₃ having a structure shown below were vapor-deposited on the secondary layer at a ratio of 17:1 to form a tertiary layer having a thickness of 1 nm. This process for forming the secondary and tertiary layers was repeated 18 times to form a thin film having a total thickness of 36 nm. During this process, a crucible on which the compound A and rubrene were placed and a crucible on which the compound A and Ir(ppy)₃ were placed were constantly heated at a temperature at which vapor deposition could be carried out, and the vapor deposition was carried out repeatedly by switching a shutter provided in the vicinity of the crucibles.

Thus, a luminescent layer having an alternating layered structure containing only one host material (compound A) was obtained. The luminescent layer had layers each containing a fluorescent and a host material (compound A) and layers each containing a sensitizer and the host material.

Compound G having a structure shown below was vapor-deposited on the luminescent layer to form an organic thin film having a thickness of 36 nm. A patterned mask with a square opening having edges of 4 mm×5 mm was placed on the organic thin film. Lithium fluoride was vapor-deposited thereon to form a layer having a thickness of 3 nm, and aluminum was then vapor-deposited on the lithium fluoride layer to form a layer having a thickness of 200 nm. A negative electrode was thus formed. The mask was removed. Direct constant voltage was applied to the resultant organic EL element with a source measure unit Type 2400 manufactured by Toyo Corporation to cause the element to emit luminescence. The brilliance of the element was measured with a brilliance meter BM-8 manufactured by Topcon Corporation. As a result, yellow luminescence having λₘₐₓ of 565 nm and chromaticity (x, y) of (0.44, 0.54) was obtained, and the external quantum efficiency at 200 cd/m² was 11.1%.

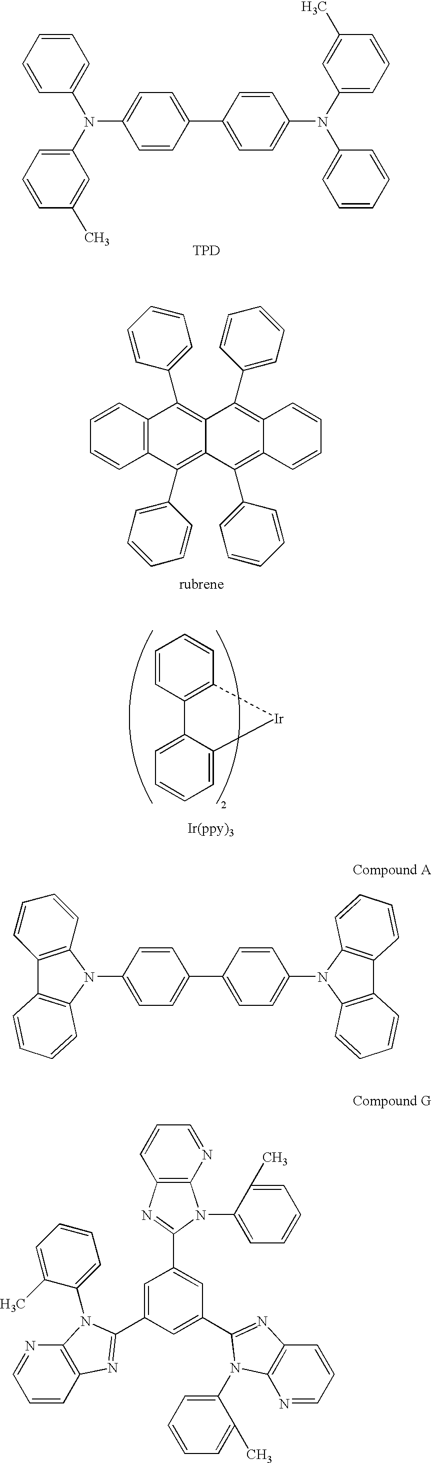

### Example 1

An indium tin oxide (ITO) substrate was washed and put into a vapor deposition device, and N,N′-diphenyl-N,N′-di(m-tolyl)benzidine (TPD) was vapor-deposited thereon to form a first layer having a thickness of 50 nm. The compound A and rubrene were vapor-deposited on the first layer at a ratio of 99:1 to form a secondary layer having a thickness of 1 nm. Next, a compound B having a structure shown below and Ir(ppy)₃ were vapor-deposited on the secondary layer at a ratio of 17:1 to form a tertiary layer having a thickness of 1 nm. This process for forming the secondary and tertiary layers was repeated 18 times to form a thin film having a total thickness of 36 nm. During this process, a crucible on which the compound A and rubrene were placed and a crucible on which the compound B and Ir(ppy)₃ were placed were constantly heated at a temperature at which vapor deposition could be carried out, and the vapor deposition was carried out repeatedly by switching a shutter provided in the vicinity of the crucibles.

Thus, a luminescent layer having an alternating layered structure containing two host materials (compounds A and B) was obtained. The luminescent layer had layers each containing a fluorescent and a host material (compound A) and layers each containing a sensitizer and another host material (compound B).

The compound G was vapor-deposited on the luminescent layer to form an organic thin film having a thickness of 36 nm. A negative electrode was formed on the organic thin film in the same manner as in Comparative Example 1. An organic EL element of Example 1 was thus obtained. The organic EL element was evaluated in the same manner as in Comparative Example 1. As a result, yellow luminescence having λₘₐₓ of 566 nm and chromaticity (x, y) of (0.45, 0.54) was obtained, and the external quantum efficiency at 200 cd/m² was 13.2%.

Hereinafter, the structures of host materials B to H used in Examples 1 to 8 are shown.

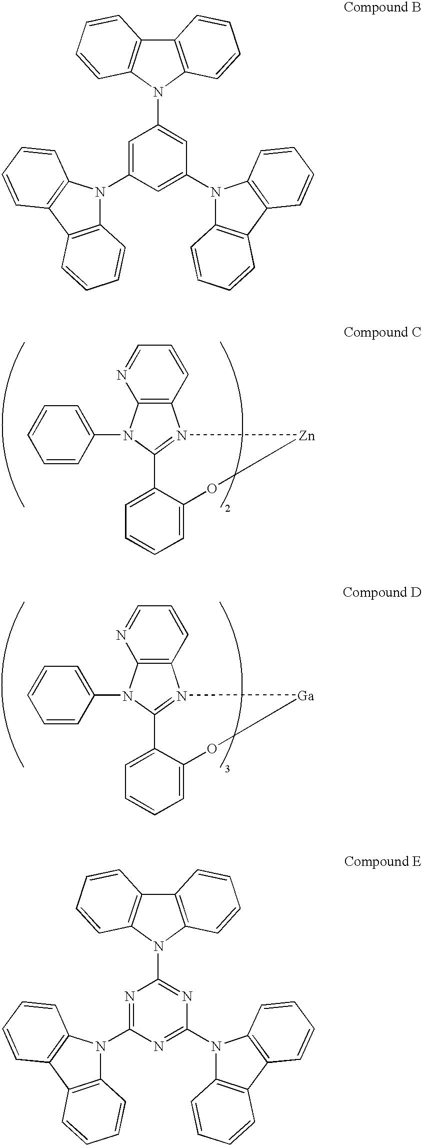

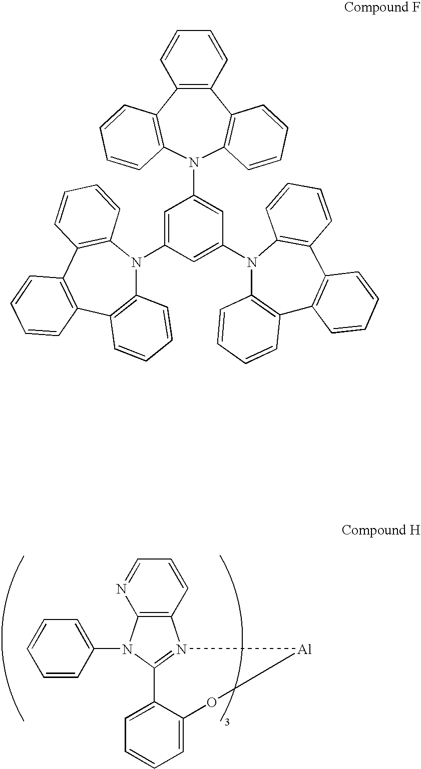

### Example 2

An organic EL element of Example 2 containing two host materials (compounds A and C) was prepared in the same manner as in Example 1, except that the compound C was used instead of the compound B. The organic EL element was evaluated in the same manner as in Comparative Example 1. As a result, yellow luminescence having λₘₐₓ of 565 nm and chromaticity (x, y) of (0.44, 0.53) was obtained, and the external quantum efficiency at 200 cd/m² was 17.6%.

As in the luminescent layer of the luminescent element of Example 1, the luminescent layer of the element of Example 2 had layers each containing a fluorescent and a host material and layers each containing a sensitizer and another host material.

### Example 3

An organic EL element of Example 3 containing two host materials (compounds B and D) was prepared in the same manner as in Example 1, except that the compound B was used instead of the compound A and that the compound D was used instead of the compound B. The organic EL element was evaluated in the same manner as in Comparative Example 1. As a result, yellow luminescence having λₘₐₓ of 563 nm and chromaticity (x, y) of (0.46, 0.52) was obtained, and the external quantum efficiency at 200 cd/m² was 13.7%.

As in the luminescent layer of the luminescent element of Example 1, the luminescent layer of the element of Example 3 had layers each containing a fluorescent and a host material and layers each containing a sensitizer and another host material.

### Example 4

An indium tin oxide (ITO) substrate was washed and put into a vapor deposition device, and N,N′-diphenyl-N,N′-di(m-tolyl)benzidine (TPD) was vapor-deposited thereon to form a first layer having a thickness of 50 nm. The compounds B and E and rubrene were vapor-deposited on the first layer at a ratio of 50:50:1 to form a secondary layer having a thickness of 1 nm. Next, the compound D and Ir(ppy)₃ were vapor-deposited on the secondary layer at a ratio of 17:1 to form a tertiary layer having a thickness of 1 nm. This process for forming the secondary and tertiary layers was repeated 18 times to form a thin film having a total thickness of 36 nm. During this process, a crucible on which the compounds B and E and rubrene were placed and a crucible on which the compound D and Ir(ppy)₃ were placed were constantly heated at a temperature at which vapor deposition could be carried out, and the vapor deposition was carried out repeatedly by switching a shutter provided in the vicinity of the crucibles. The compound G was vapor-deposited on the luminescent layer to form an organic thin film having a thickness of 36 nm.

A negative electrode was formed on the organic thin film in the same manner as in Comparative Example 1. An organic EL element of Example 4 with a luminescent layer containing, as host materials, compounds B, E, and D was thus obtained. The organic EL element was evaluated in the same manner as in Comparative Example 1. As a result, yellow luminescence having λₘₐₓ of 566 nm and chromaticity (x, y) of (0.45, 0.55) was obtained, and the external quantum efficiency at 200 cd/m² was 14.1%.

The luminescent layer of the luminescent element of Example 4 had layers each containing a fluorescent and two host materials and layers each containing a sensitizer and one host material different from the two host materials.

### Example 5

An indium tin oxide (ITO) substrate was washed and put into a vapor deposition device, and N,N′-diphenyl-N,N′-di(m-tolyl)benzidine (TPD) was vapor-deposited thereon to form a first layer having a thickness of 50 nm. The compounds F and G and rubrene were vapor-deposited on the first layer at a ratio of 50:50:1 to form a secondary layer having a thickness of 1 nm. Next, the compounds C and H and Ir(ppy)₃ were vapor-deposited on the secondary layer at a ratio of 9:8:1 to form a tertiary layer having a thickness of 1 nm. This process for forming the secondary and tertiary layers was repeated 18 times to form a thin film having a total thickness of 36 nm. During this process, a crucible on which the compounds F and G and rubrene were placed and a crucible on which the compounds C and H and Ir(ppy)₃ were placed were constantly heated at a temperature at which vapor deposition could be carried out, and the vapor deposition was carried out repeatedly by switching a shutter provided in the vicinity of the crucibles. The compound G was vapor-deposited on the luminescent layer to form an organic thin film having a thickness of 36 nm.

A negative electrode was formed on the organic thin film in the same manner as in Comparative Example 1. An organic EL element of Example 5 with a luminescent layer containing, as host materials, compounds F, G, C and H was thus obtained. The organic EL element was evaluated in the same manner as in Comparative Example 1. As a result, yellow luminescence having λₘₐₓ of 563 nm and chromaticity (x,
y) of (0.42, 0.55) was obtained, and the external quantum efficiency at 200 cd/m² was 14.6%.

The luminescent layer of the luminescent element of Example 5 had layers each containing a fluorescent and two host materials and layers each containing a sensitizer and two host materials different from the above two host materials.

### Example 6

An indium tin oxide (ITO) substrate was washed and put into a vapor deposition device, and N,N′-diphenyl-N,N′-di(m-tolyl)benzidine (TPD) was vapor-deposited thereon to form a first layer having a thickness of 50 nm. The compound C and rubrene were vapor-deposited on the first layer at a ratio of 99:1 to form a secondary layer having a thickness of 1 nm. Next, the compounds F and G and Ir(ppy)₃ were vapor-deposited on the secondary layer at a ratio of 10:7:1 to form a tertiary layer having a thickness of 1 nm. This process for forming the secondary and tertiary layers was repeated 18 times to form a thin film having a total thickness of 36 nm. During this process, a crucible on which the compound C and rubrene were placed and a crucible on which the compounds F and G and Ir(ppy)₃ were placed were constantly heated at a temperature at which vapor deposition could be carried out, and the vapor deposition was carried out repeatedly by switching a shutter provided in the vicinity of the crucibles. The compound G was vapor-deposited on the luminescent layer to form an organic thin film having a thickness of 36 nm.

A negative electrode was formed on the organic thin film in the same manner as in Comparative Example 1. An organic EL element of Example 6 with a luminescent layer containing, as host materials, compounds C, F, and G was thus obtained. The organic EL element was evaluated in the same manner as in Comparative Example 1. As a result, yellow luminescence having λₘₐₓ of 564 nm and chromaticity (x, y) of (0.43, 0.54) was obtained, and the external quantum efficiency at 200 cd/m² was 13.0%.

The luminescent layer of the luminescent element of Example 5 had layers each containing a fluorescent and a host material and layers each containing a sensitizer and two host materials different from the host material.

### Example 7

An organic EL element of Example 7 with a luminescent layer containing three host materials (compounds F, G, and H) was prepared in the same manner as in Example 5, except that the compound F was used instead of the compound C. The organic EL element was evaluated in the same manner as in Comparative Example 1. As a result, yellow luminescence having λₘₐₓ of 563 nm and chromaticity (x, y) of (0.43, 0.55) was obtained, and the external quantum efficiency at 200 cd/m² was 12.6%.

The luminescent layer of the luminescent element of Example 7 had layers each containing a fluorescent and two host materials and layers each containing a sensitizer and the two host materials.

Evaluation of Durability

The initial brilliance of each of the luminescent elements of Comparative Example 1 and Examples 1 to 7 was adjusted at a predetermined value and then the half-life period of brilliance of each element was measured. The half-life period of the luminescent element of Comparative Example 1 was six hours, and those of the luminescent elements of Examples 1 to 7 were 10 hours, 9 hours, 13 hours, 16 hours, 15 hours, 18 hours and 28 hours, respectively.

From the above evaluation results of Comparative Example 1 and Examples 1 to 7, it was found that the luminescent element of the invention with a luminescent layer containing two host materials has excellent luminescence efficiency, and long half-life period and in turn excellent durability. Meanwhile, it was confirmed that the luminescent element of Comparative Example 1 containing only one host material is inferior to the luminescent elements of Examples in view of both luminescence efficiency and durability.

1. An organic electroluminescent element comprising:
a pair of electrodes; and
at least one organic compound layer including a luminescent layer between the pair of electrodes,
wherein the luminescent layer contains a fluorescent, which emits fluorescent light when voltage is applied to the element, a sensitizer for amplifying the number of singlet excitons that occur when voltage is applied to the element so as to amplify the luminous intensity of the fluorescent, and other materials.

2. The organic electroluminescent element of claim 1, wherein the luminescent layer comprises a layered structure of at least one layer comprising the fluorescent and at least one layer comprising the sensitizer.

3. The organic electroluminescent element of claim 2, wherein the layer comprising the fluorescent includes a host material, and the layer comprising the sensitizer includes another host material.

4. The organic electroluminescent element of claim 2, wherein at least one layer selected from the layer comprising the fluorescent and the layer comprising the sensitizer includes two host materials.

5. The organic electroluminescent element of claim 1, wherein the fluorescent is an aromatic condensed ring compound.

6. The organic electroluminescent element of claim 2, wherein the fluorescent is an aromatic condensed ring compound.

7. The organic electroluminescent element of claim 3, wherein the fluorescent is an aromatic condensed ring compound.

8. The organic electroluminescent element of claim 4, wherein the fluorescent is an aromatic condensed ring compound.

9. The organic electroluminescent element of claim 1, wherein the sensitizer is a transition metal complex.

10. The organic electroluminescent element of claim 2, wherein the sensitizer is a transition metal complex.

11. The organic electroluminescent element of claim 3, wherein the sensitizer is a transition metal complex.

12. The organic electroluminescent element of claim 4, wherein the sensitizer is a transition metal complex.
